(19) United States
(12) Patent Application Publication
(10) Pub. No.: US 2006/0040020 A1
(43) Pub. Date: Feb. 23, 2006

(54) Food product

(76) Inventor: Rafael Maric, Andrews (AU)

Correspondence Address: SUGHRUE MION, PLLC, 2100 PENNSYLVANIA AVENUE, N.W., SUITE 800, WASHINGTON, DC, 20037, US

(21) Appl. No.: 10/504,466

(22) PCT Filed: Feb. 13, 2002
(86) PCT No.: PCT/AU02/00147

§ 371 Date: Nov. 12, 2004

(30) Foreign Application Priority Data
Jul. 27, 2001 (AU) PR 6673
Dec. 17, 2001 (AU) PR 9554

(51) Int. Cl. A23G 1/00

(52) U.S. Cl. 426/104

(57) ABSTRACT

A food product is disclosed and the product includes a body which may be a packaging containing or be formed of one or more edible elements. The body or each of said one or more edible elements having means for hanging the body on a food vessel. The body or each of the edible elements can have interconnectable pieces with one of the pieces provided with the hanging means.

### TECHNICAL FIELD OF THE INVENTION

THIS INVENTION relates to an improved food product having a body configured so that it can be supported on a food vessel.

This invention also relates to an improved food product for facilitating using the food product for dipping and/or gathering other food item(s) thereon.

This invention further relates to a holder device for holding one or more articles.

### BACKGROUND OF THE INVENTION

Food products such as sliced bread, toasts, dry biscuits, confectionery in the form of chocolate bars, jubes, and lollies, sausages and other finger foods are generally eaten while being held with fingers.

When such food products are served with drinks at a function they are usually placed on plates or in bowls for people at the function to take them for consumption. The food products on the plates or in the bowls are either presented to persons personally or placed on a table for any person to take. Following taking of the food products these people will not have a free hand as they need to use one hand to hold the drink containers and the other hand to hold the food products. Many people habitually use hand gestures for emphasising purposes during conversation. Without a free hand they are hindered to some extent during conversation. As another example, when a person holds two glasses of drinks, he/she does not have a free hand. In this circumstance, it is not possible to take snack foods at the same time.

Likewise, young children when holding a cup or glass of hot or cold drink with one hand and a food product with the other hand, are prone to spill the drinks as at their ages their hands are usually not sufficiently large to hold the cups or glasses steadily. Accordingly, it would be desirable for the children to hold the cups or glasses with both hands at least occasionally in order to ensure that the drinks do not spill. If the children are yet to be sufficiently steady when standing or walking, they would need a free hand to hold onto a fixed structure or a person in order to help balancing. Without a free hand and to attempt prevent falling, the children would tend to grasp onto a fixed structure or a person. This would soil the fixed structure or person as the children would inevitably keep holding the food product while using the food product holding hand for grasping. If there is no structure or person to hold on to, the children with a free hand will fall in a relatively safer manner as they would be able use their free hands to reduce the impact of falling.

Some of these food products are used to gather other food items such as sauce or dips for eating together with the food products. The food products known to the applicant are generally in the form of a circular, oval or rectangular shaped disk. When using the food products to gather such food items the food products are held between the thumb and the fore finger of one hand and are pushed forwardly and downwardly into the food items to gather a certain amount of them onto the food products before lifting the food products off the foot items by turning the wrist of that hand and lifting the arm. People suffering from arthritis in the wrist joints or other wrist problems find it difficult to perform such actions. Such action also prone to cause accidental contact of the fingers with the food items.

As referred to above, the abovementioned food products are generally placed in a container such as a plate, a tray or a bowl, for people to pick therefrom. The food products may be arranged in stacks or close to each other. When taking a piece of the food products it is difficult to avoid contacting another piece of the food products in the container. If the food products are a mixture of different types, people would like to choose the ones they prefer to eat. Having food products of different types therefore would multiple by many folds the chances of a person in choosing a particular type of the products to contact food products remaining on the container.

If the food products are relatively small such as chocolate blocks, jubes, jelly beans, lollies, nuts, small pieces of biscuits or cakes, and the like, it is desirable that they can be placed somewhere when one wants to have a free hand while the other hand is holding a drink or food container.

Dough for making a cake, biscuits or bread, and meat for making sausages such as salami and the like undergo a heating process before they are edible. The dough and the meat are usually in a lump form and are difficult to heat evenly. If the temperatures set for the heating processes are too high, the inner portion of the dough or the meat may be still raw when outer portion thereof is cooked. Conversely, the heating process will take too long. In either case, the differential of the heat received by the outer and the inner portions is large and the two portions of the dough or meat are not cooked evenly.

In cafes and restaurants, toasts are made by firstly slicing a loaf of bread and then placing the slices of bread on a hot plate or in an oven. As the slices have thin edges around broad faces, they are positioned with one of the broad faces on the hot plate or on a rack in the oven. When a hot plate is used for toasting, the slices of bread need to be turned so that both faces are toasted When an oven is used for toasting, one face tends to be crispier than the opposite face.

The applicant has observed that at many home and office functions, and in some self-serviced eating establishments, materials for making drinks like cups, coffee and tea, tea spoons, sugar, etc. are placed on a table. Guests wanting to have a drink must wait in turn to get to the table to take the appropriate materials therefrom for making the drink. As a consequence, a large number of the guests would be around the table waiting to get the materials to make drinks. The waiting periods can be considerable and many of the waiting guests would give tip the hope of getting a hot drink.

### OBJECT OF THE INVENTION

An object of the present invention is to provide a food product which alleviates or reduces to a certain level one or more of the above disadvantages.

### SUMMARY OF THE INVENTION

In a first aspect, although it need not be the only or the broadest aspect, the invention resides in a food product adapted to hang from a food vessel having an inner wall and an external wall which terminates in a top rim. The food product preferably includes a body and a first hook. The first hook is preferably formed by an indentation at one end of the body. The hook is formed with a free end inturned toward die body to attach the product to the vessel and provide three spaced contact points. A first contact point will be between the free end and the inner wall, a second contact point is between the top rim and the indentation and a third contact point is between the body and the external walls.

Preferably the third contact point is below the free end of the first contact point although it may be higher and may even be within the indentation.

In one embodiment, the food product includes a second hook formed in a similar manner to the first hook but spaced therefrom. Preferably the first hook and second hook are each disposed at opposite ends of the body.

The food product may be formed in the shape of a fictional or real character. It may be formed as a likeness to a plant, scenery, a work tool, building structure and a vehicle or any other suitable shape. If the food product is a real or created character, the hook or hooks may be formed by one or more appendages. The food product may include a space created in the body and adapted to receive a handle of a food vessel. The food product may be formed from any one or more of biscuit, bread, cake, sausage or chocolate or other suitable material.

In one embodiment, the food product may be formed by two or more interconnectable elements. These elements may be formed in a jigsaw type pattern.

The food product may comprise one or more through holes. These through holes may have a beneficial effect during manufacture.

The food product may be formed as a ladder having a second hook spaced from the first hook with both hooks adapted to hang from the top rim of the food vessel. The ladder may be adapted to receive and support further hanging food elements.

The invention extends to a system for storing a food product on an elongate member which extends substantially horizontally. The elongate member may be supported by two or more spaced legs with upper ends extending from the elongate member and lower ends adapted to rest on a surface such as a table. The system includes at least one food product according to the present invention arranged on the member. The elongate member may be fixed to a rail of a display unit.

In some circumstances, the food product may be formed from a block of edible material wherein slicing the block of edible material, preferably transversely, provides the food product.

The invention also extends to a method of forming a food product adapted to hang from a food vessel. The method comprises the step of forming a body and then forming the indentation to provide a first hook substantially as described above. The method may include the step of turning an end member about a pin to a desired configuration.

In a further aspect therefore, the present invention resides in a food product including a body which contains or is formed of one or more edible elements and the body or each of said one or more edible elements having means for hanging the body on a food vessel.

In this specification, the term “food vessel” wherever used is to be taken to include a drinks vessel and/or a food vessel.

In another aspect therefore the present invention resides in a food product including a body having a first member with a first free end and a second member with a second free end, the first and second members being joined together or formed integrally in a manner that the first member extending divergently from the second member. The first and second members are configured so that when a person holding one of the first and second ends the other of said first and second ends or first and second members presents a distinct surface for gathering food items or for dipping in drinks in an open food vessel.

The body may be a packaging for containing the one or more edible elements. The packaging can be in the form of a casing having two interconnectable packaging halves.

The body may also be formed of two or more edible elements which are configured for interlocking relationship between two adjacent elements, and at least one of the element including the hanging means.

The body may be a block of edible material and the one or more edible elements can be slices obtained by slicing the block. The block can be a loaf of bread, or shaped dough for making into bread, cake, or biscuit, or a cooked or uncooked sausage.

The body preferably has a first member with a first free end and a second member with a second free end, the first and second members being joined together or formed integrally in a manner that the first member extending divergently or in a substantially opposite direction from the second member. The first and second members are configured so that at least one of the first and second ends forming the hanging means for hanging the body on the food vessel. Typically, the hanging means is formed with an indentation. For this aspect, it is also preferred that at least one of said first and second ends or members presents a distinct surface for gathering food items or for dipping in drinks in an open container. Advantageously, the first and second members are configured so that when the food product is hung on a wall or a handle of the food vessel, an edge of the member remote from the indentation is in contact with said wall or said handle. This configuration provides increased stability to the food product when being supported on the food vessel. The indentation(s) may be in any shape but it is preferred that it is hook-shaped.

The angle of divergence between the first and second members can be any angle within the range of 30° to 170°. In one specific form the angle of divergence is 145°.

The body may have a mid region and the first and second members extend divergently or in a substantially opposite direction from the mid region. Advantageously, the mid region is shaped so that a person may hold on to a part of said mid region when eating food items gathered on one of or both said first and second ends. The food items gathered on said first and second ends may be different so that a person does not need to use different food products for gathering food items.

At least said one of the first and second members is advantageously shaped so that it has a relatively narrow width at its free end and the width increases progressively towards its opposite end. Typically both said first and second members are shaped so that each of them has a relatively narrow width at its free end and the width increases progressively towards its opposite end. In an example the body is shaped substantially in the form of a shallow V. In another example the body is shaped substantially in the form of a boomerang.

The distinct surface of the food product according to the present invention enables and encourages people using it to gather food items to do it with a spreading action that requires no or little wrist action. Accordingly, people with wrist problems can use it to gather food items comfortably.

When the food product is supported on a food vessel, the person has a free hand for gesturing during communication. It also offers the convenience of providing a free hand to stabilise the holder when travelling or using stairs etc.

The food product may be in the form of a dry biscuit (savoury or sweet), or a cake, or a piece of bread, or sweets, or a chocolate bar, or a sausage.

One or more of the first member and the second member can be configured so that the food product can be supported about a handle of a food or drink vessel. Preferable, the first member is configured with a single indentation along the edge, and the indentation is shaped for resting over the top part of the handle. More preferably, the second member is configured so that it can rest On the lower part of the handle.

In one form, the second member is shaped so that it extends into the handle. In another form, the second member has an indentation shaped to receive the lower part of the handle.

The body and/or the food element(s) of the food product may be formed in the shape of a real or created character and/or plant and/or scenery and/or work tool, and/or building structure, and/or vehicle. The body and/or the food element(s) of the food product may be formed as interconnectable pieces which when fully connected would represent a real or created character and/or plant and/or scenery and/or work tool, and/or building structure, and/or vehicle.

In another further aspect therefore the present invention relates to a holding system for one or more of the food products as hereinbefore described. The system includes an elongated member arranged to extend in a horizontal direction, and the elongated member being configured to cooperate with the hanging means of the food product(s) to thereby allow hanging of the food products there about.

The elongated member may have a fixing arrangement at one end thereof for fixing the elongated member to a rail of a display unit Alternately, the holding system may have vertically arranged spaced legs with upper ends thereof extending from the elongated member and lower ends thereof adapted to rest on a surface, whereby the elongated member is supported above the surface. Typically, the elongated member and the spaced legs are formed of a bent wire.

In a yet further aspect therefore the present invention resides in a holder device for holding one or more articles. The holder device 100 has a body with a receptacle section for holding the article(s) and a support section configured for supporting on a part of a food or drink vessel.

The article(s) may include any article(s) that need to be used with the vessel. The article(s) may be a tooth brush(es), and/or tooth paste container(s); or a spoon(s), and any of sugar, tea, coffee, or biscuits.

The receptacle section may have a base with apertures for draining liquid in the receptacle section.

The support section may have one or more support hooks for hanging on the a part of the vessel.

The receptacle section may have one or more compartments for accommodating the article(s).

The holder device may also have a leg section for positioning the device on a surface.

### BRIEF DESCRIPTION OR THE DRAWINGS

In order that the present invention can be more readily understood and be put into practical effect reference will now be made to the accompanying drawings which illustrate embodiments of the present invention and wherein:—

FIG. 1 is a schematic plan view showing one application of an embodiment of the food product according to the present invention;

FIG. 2 is a schematic plan view showing another application of the embodiment shown in FIG. 1;

FIG. 3 shows the food product shown in FIG. 1 with different food items at its ends;

FIG. 4 shows a person holding the food product shown in FIG. 3 and in the process of presenting one end of the food product for eating;

FIG. 5 is a schematic plan view showing a further application of the embodiment shown in FIG. 1;

FIG. 6 is a schematic plan view showing a second embodiment of the food product according to the present invention;

FIG. 7 is a schematic plan view showing a third embodiment of the food product according to the present invention;

FIG. 8 is a schematic plan view showing a fourth embodiment of the food product according to the present invention;

FIGS. 9 to 11 show further embodiments of the food product according to the present invention;

FIG. 12 is a schematic perspective view showing yet another embodiment of the food product according to the present invention;

FIG. 13 shows an application of the food product shown in FIG. 12;

FIG. 14 shows an embodiment of the food product according to the present invention that can be hung on the handle or about the top edge of a drink container;

FIG. 15 is a side view of the embodiment of the food product shown in FIG. 14

FIGS. 16 and 17 are respective plan and side views of yet another further embodiment of the food product according to the present invention;

FIG. 18 shows an application of the embodiment of the food product shown in FIGS. 16 and 17;

FIGS. 19 to 21 some embodiments of novelty type food products according to the present invention;

FIGS. 22 shows steps in making a food product according to the present invention;

FIG. 23 shows another form of the product that can be made using the steps shown in FIG. 22;

FIGS. 24 shows a sliceable food product according to the present invention;

FIG. 25 is a holding system for holding an embodiment of the food product according to the present invention;

FIG. 26 is another holding system for holding a boxed embodiment of the food product according to the present invention;

FIG. 27 shows a boxed food product according to the present invention in an open stage;

FIG. 28 shows an application of the boxed embodiment of the food product according to the present invention;

FIG. 29 shows an application of an embodiment of the food product having connectable food elements according to the present invention;

FIG. 30 shows a plan view of an embodiment of a holder device according to the present invention; and

FIG. 31 shows a plan view of another embodiment of a holder device according to the present invention;

### DETAILED DESCRIPTION OF THE INVENTION

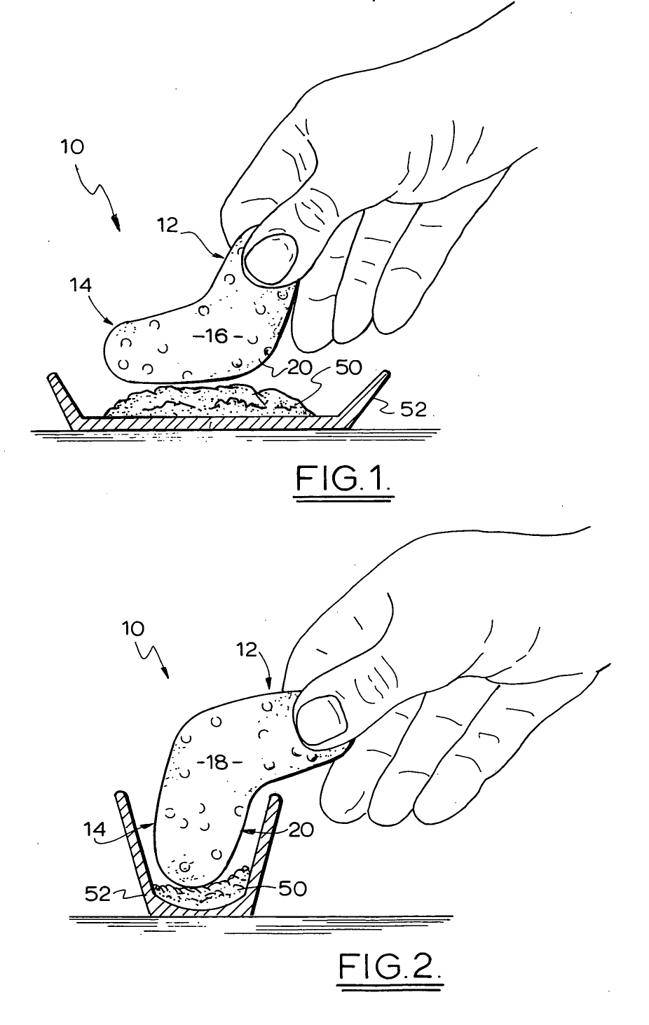

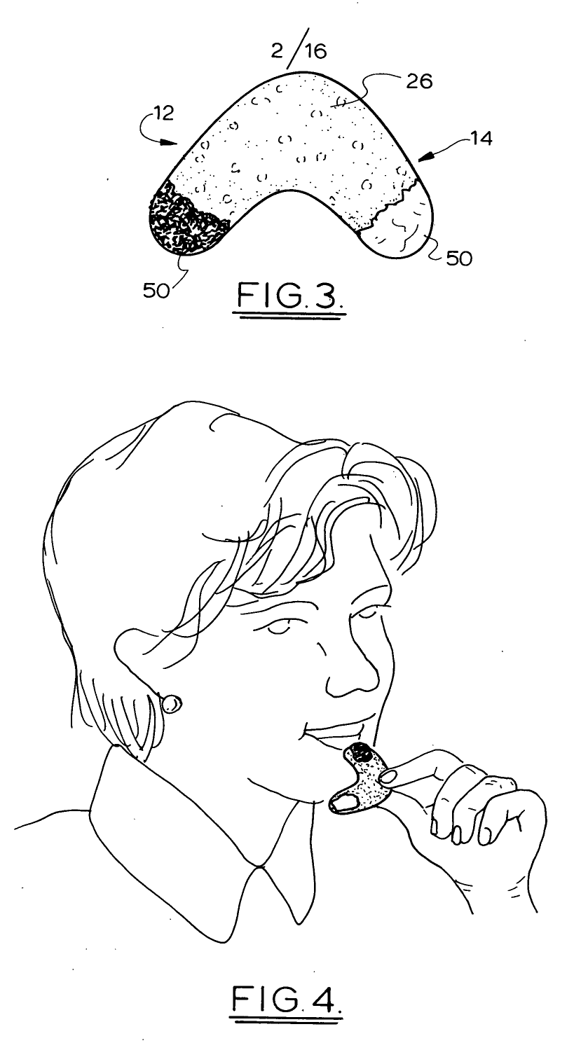

Referring to the Figures and initially to FIG. 1, there is shown an embodiment of the food product 10 according to the present invention. The food product 10 in this embodiment is in the from of a savoury biscuit and comprises a body having a first member 12 and a second member 14 formed integrally with the first member 12. The members 12 and 14 are arranged together form a planar face 16, a planar face 18 (see FIG. 2) opposite to the face 16, and a continuous edge 20 around the faces 16 and 18.

The members 12 and 14 diverge from each other at an angle of about 145° and have a width that increases progressively from their respective free ends towards the middle of the body. As such the body is a substantially boomerang shaped disk.

In use, a person holds the free end of either member 12 or member 14 for gathering food items such as a sauce or a savoury dip onto a part of the face 16 or 18 remote from the member 12 or 14 being held. FIG. 1 illustrates the member 12 of the biscuit 10 being held between the thumb and fore finger of the person's right hand and a long part of the edge 20 of the member 14 is just about to be spread across a savoury dip 50 in a dish 52 for gathering an amount of the dip 50 onto the surface 16. As can be seen in FIG. 1 said long part of the edge 20 is substantially horizontal and the spreading action requires no or little wrist action. As such, people suffering from wrist problem such as arthritis can use the biscuit 10 for gathering the dip 50 without pain. As the member 12 is divergent and remote to the member 14, and the spreading action is across the dip 50, there is little risk that the person's hand will come in contact with the dip 50. In addition, as the long part of the edge 20 is substantial in length, there is no need to insert too much of the body into the dip 50 in order to gather sufficient dip 50 onto the biscuit 10 for consumption.

FIG. 2 shows the biscuit 10 being used to gather the dip 50 with the part of the edge 20 at the free end of the member 14. Again the gathering action is by spreading the free end part of the edge 20 across the dip 50. There is no or little need to use the turn wrist for this spreading action. There is also little risk of the hand contacting the dip 50 while gathering the dip 50 onto the face 18, in this case.

The biscuit 10 has a mid portion 26 as shown in FIG. 3 for a person to hold onto when it is desired to gather food items 50 on both free ends. As shown in FIG. 4, the person holds the biscuit 10 at a part of the mid portion 26 while presenting the food item 50 on any one of the free ends for eating. This allows the person to use the same biscuit 1 0 to gather different food items 50 without the risk of mixing the different food items 50. It also saves the person who has just tasted a food item 50 and desires to taste a different food item 50 from having to go back to take another biscuit 10 to gather the different food item 50.

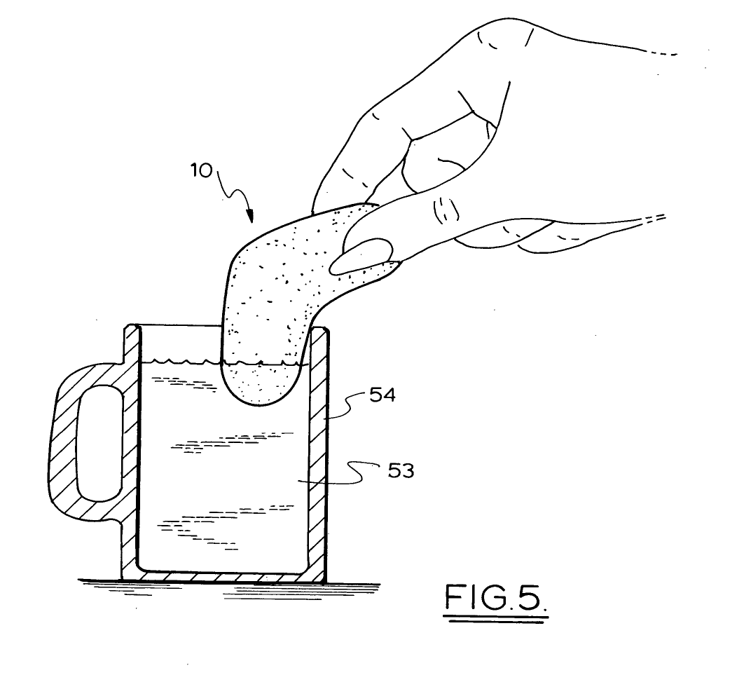

In FIG. 5, the biscuit 10 is shown being dipped in a drink 53 within a mug 54. In this application, the hand is at a certain distance from the top of the drink 53. Accordingly, there is little risk of contacting the drink 53. This helps to avoid scalding to children or the elderly if the drink 53 is hot.

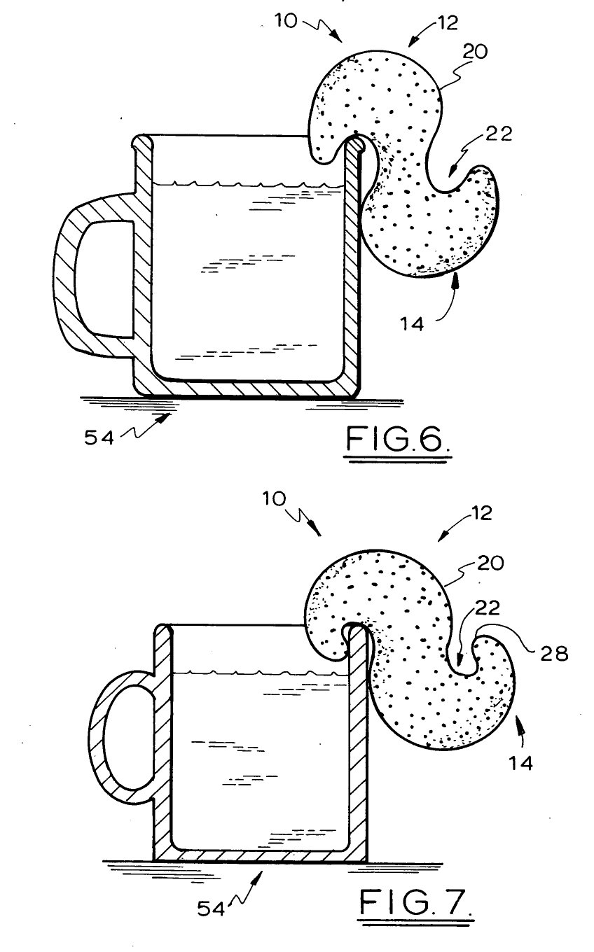

Turning to FIG. 6, the biscuit 10 in this embodiment has hanging means which in this embodiment are formed by two opposed indentations 22 along the edge 20.The indentations 22 in this embodiment is substantially hook shaped but they can be any shape as long as one of them can be supported over the top rim of the mug 54 (or any food or drink vessel). The indentations 22 are shaped so that when one the indentations is supported on the top rim of the mug 54 a part of the edge 20 comes into contact with the external surface of the wail of the mug 54, thereby the biscuit 10 is substantially steadily supported in that position. Therefore there is no need to serve biscuits on a plate or bowl. At the same time the person can hold the mug 54 with the biscuit 10 supported thereon with one hand, while the other hand is free to gesture while communicating.

In FIG. 7, the indentations 22 and the free ends of the first and second members 12 and 14 of the biscuit 10 are configured so that when one the indentations is supported on the top rim of the mug 54 the tip 28 of the adjacent free end also contacts the inner surface of the wall of the mug 54. The configuration provides an even more stable support for the biscuit 10 as the biscuit 10 has three contact points with the mug 54.

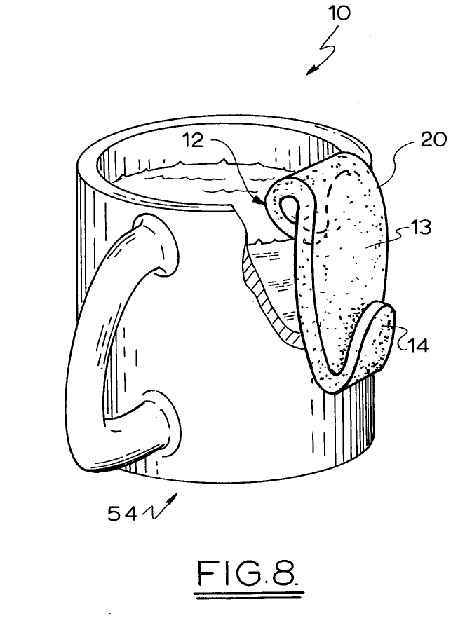

The embodiment of the food product 10 shown in FIG. 8 is a biscuit which has a first member 12 and a second member 14 formed with a substantially straight central portion 13. The members 12 and 14 are bent towards the central portion 13 so that the regions between the respective members 12 and 14, and the portion 13, form hanging means for hanging onto a food container such as the mug 54 shown in FIG. 8.

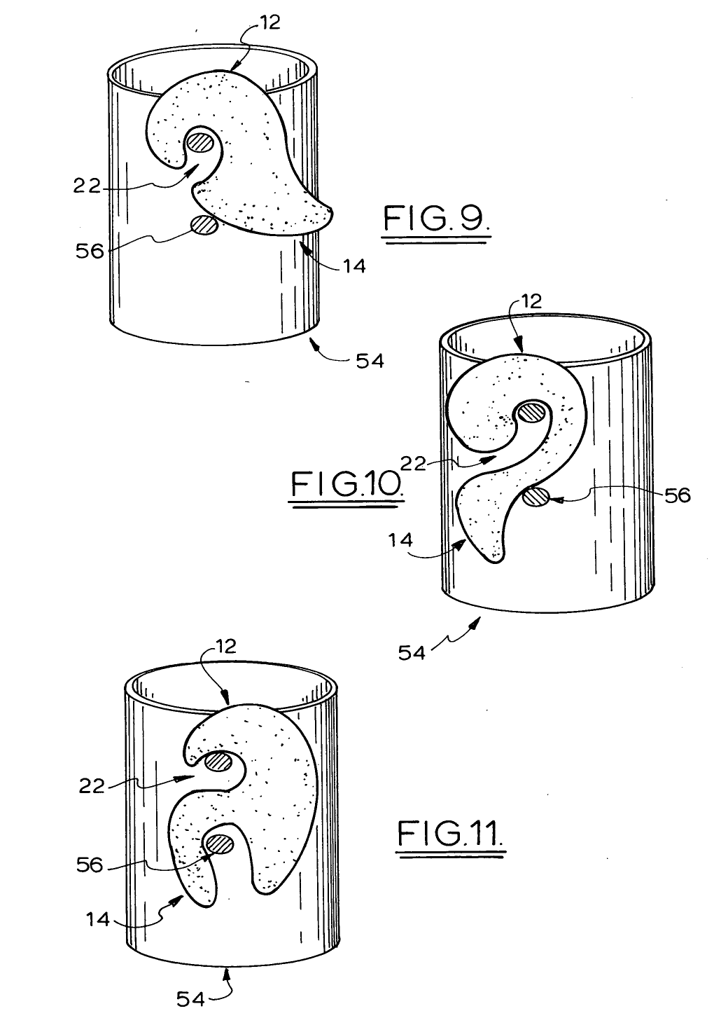

In FIGS. 9 to 11, the biscuit 10 has its first member 12 and its second member 14, configured so that it can be supported on about the handle 56 (shown in cross-section). As can be seen the first member 12 is substantially similar to the first member 12 described in the preceding embodiments. In this regard, the first member 12 of each of the biscuits 10 shown in FIGS. 9 and 10 is configured with a single indentation 22 along the edge 20.The indentations 22 in this embodiment is substantially hook shaped but can be any shape as long it can be supported over the top part of the handle 56 of the mug 54 (or any food or drink vessel). The second member 14 of the biscuit 10 in FIGS. 9 and 10, however, does not have an indentation, and is configured so that it can rest on the lower part of the handle 56.

In FIG. 10, the second member 14 is shaped so that it extends into the handle.

In FIG. 11, the second member 12 also has an indentation 22 shaped to receive the lower part of the handle 54.

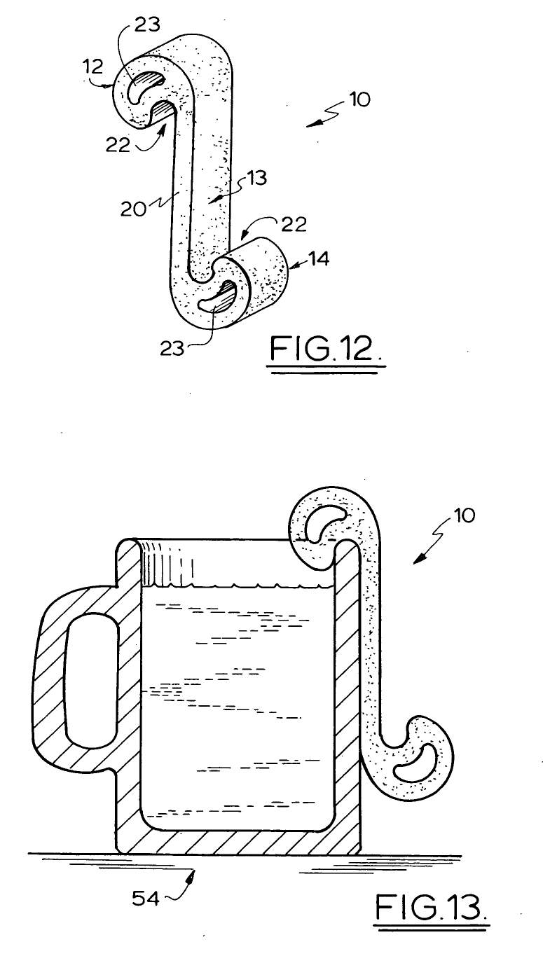

The embodiment of the food product 10 shown in FIG. 12 is a variation of the one shown in FIG. 8 as it also has a substantially straight portion 13 formed between a first end member 12 and a second end member 14. Each of the end members 12 and 14 is formed with a slightly curved recess or indentation 22 and a through hole 23. The through holes 23 reduces the thickness of the members 12 and 14 and allow hot air to flow through to thereby providing substantially even temperature to all parts of the product 10 during a baking process. This ensures that all parts are cooked in about the same time. FIG. 13 shows the product 10 of FIG. 12 being supported about the rim of s mug 54. As can be seen, a substantial surface of the central portion 13 is in contact with the mug 54. This adds to support stability.

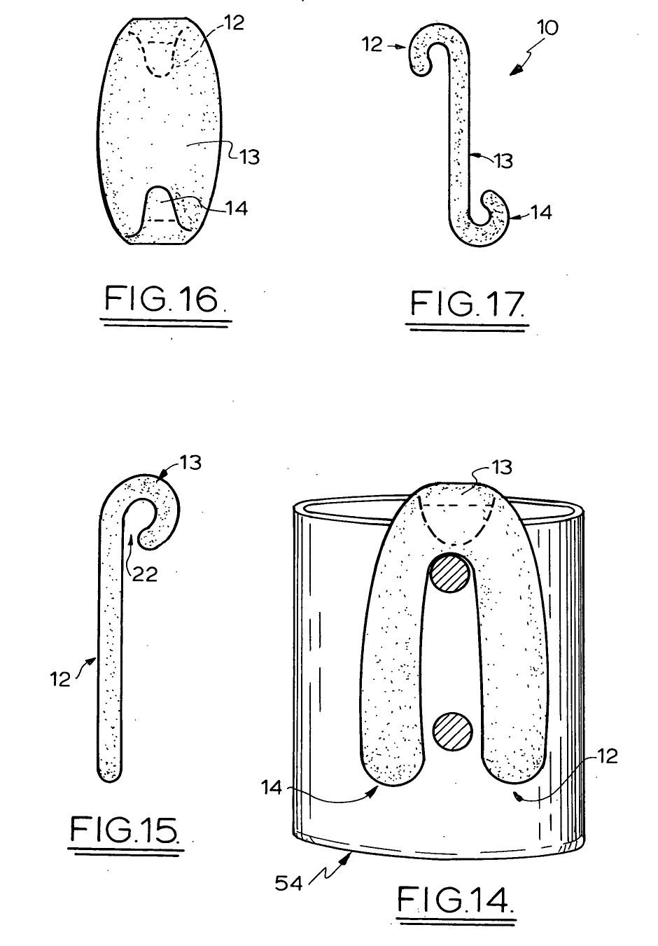

FIGS. 14 and 15 show a substantially V-shaped food product 10 according to the present invention. In this embodiment, the first and second end members 12 and 14 are relatively long and extend in a substantially parallel direction from the central portion 13. The central portion 13 is bent to form a recess 22 for hanging about the rim of a mug 54. The space between the members 12 and 14 can receive the handle of the mug 54 for supporting the food product 10 as shown in FIG. 14.

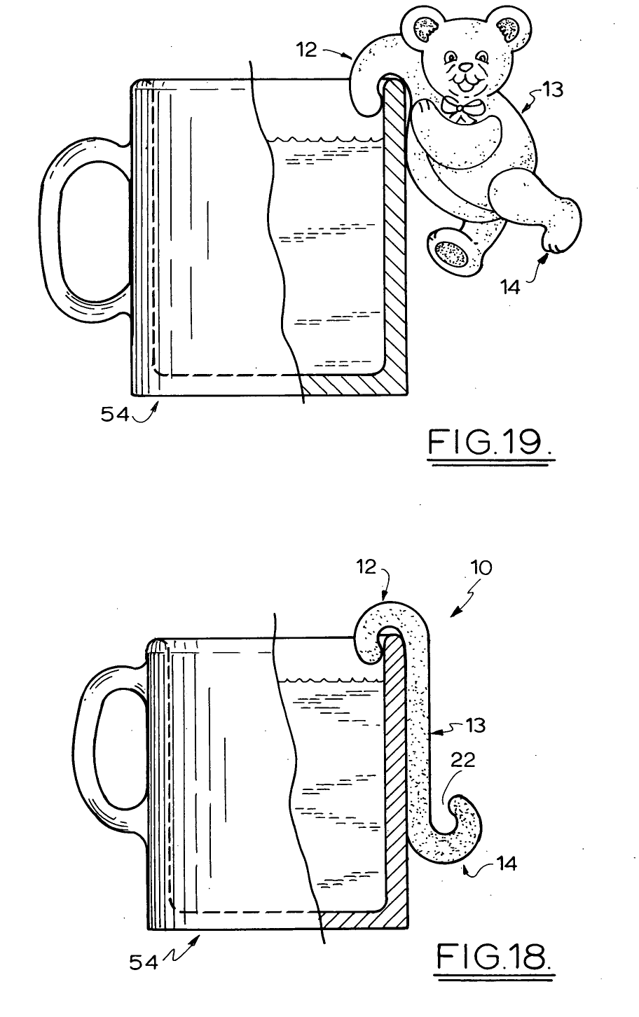

FIGS. 16 and 17 shows a variation of the embodiment of the food product shown in FIG. 8. In this variation, the end members 12 and 14 are relatively narrower. An application of the food product 10 shown in FIGS. 16 and 17 is shown in FIG. 18.

In FIG. 19, the food product 10 is formed in the shape of a bear, with the bear body constituting the central portion 13 and a bent arm as an end member 12 and a bent leg as the end member 14. In the application as shown, the arm 12 is hung about the rim of a mug 54.

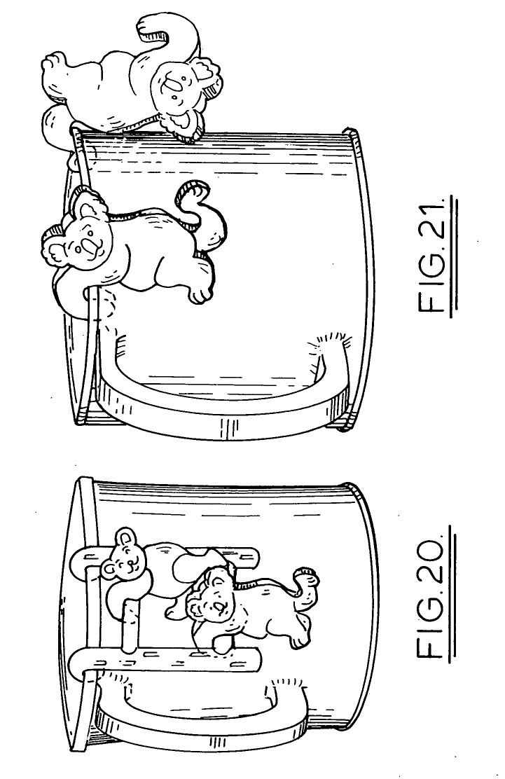

In the embodiment shown in FIG. 20, the food product 70 is in the form of two animals, a bear and a koala hanging on a ladder and the ladder has bent upper ends as the hanging means for hanging the product 10 as shown.

FIG. 21 illustrates the manners of supporting animal shaped food products 10 about the mug 54. As can be seen, the bent arm 12 and the bent leg 14 of the animal shaped food products 10 are placed over the rim of the mug 54 for hanging about the mug 54.

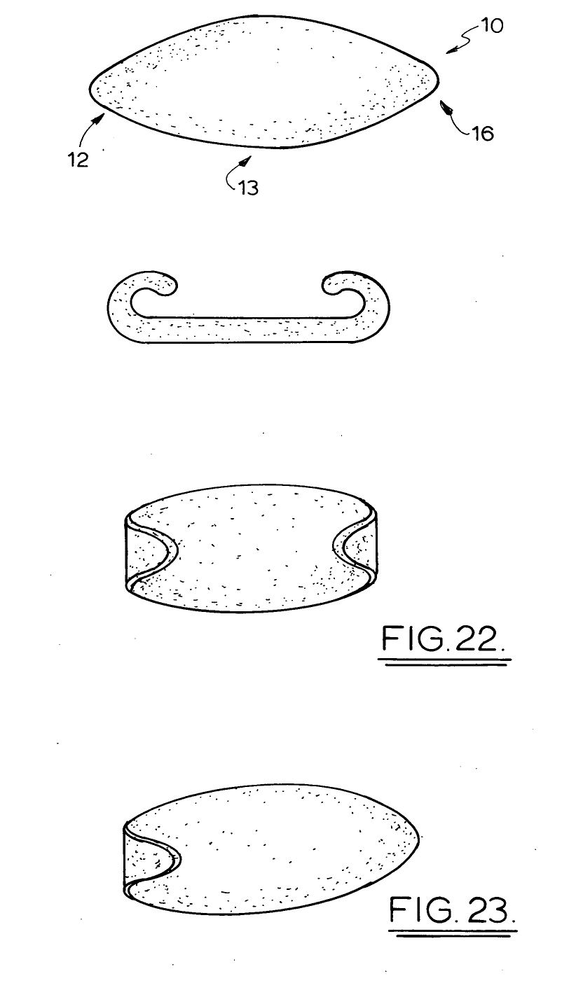

In FIG. 22, the top drawing shows a flat dough for a biscuit 10. At this stage, the end members 12 and 14 are flat and in the same plan as the middle portion. To bend the end members 12 and 14, pins (not shown) of a suitable size are placed inwardly of the respective ends of the dough 10 and the end members 12 and 14 are turned about the pins to form the shaped as shown in the middle drawing of FIG. 22. The bottom drawing in this Figure is a plan view of the dough 10 following bending of the end members 12 and 14.

FIG. 23 shows a variation of the food product 10 with one bent end member 12 instead of two as shown in FIG. 22.

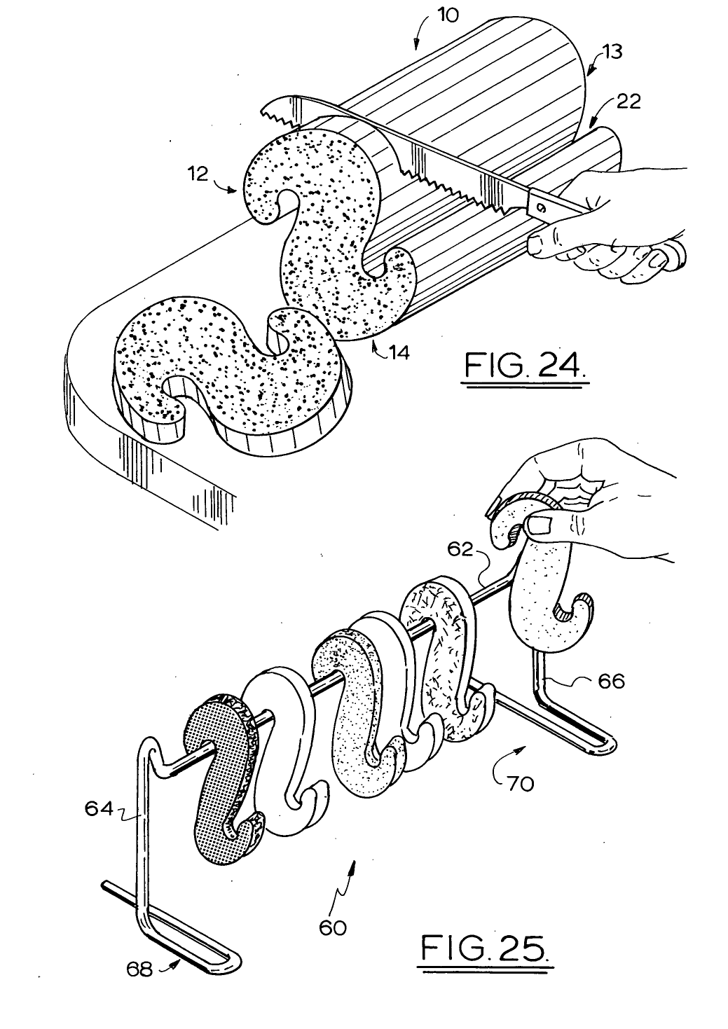

FIG. 24 shows an embodiment of the food product 10 in the form of a loaf of bread. The bread 10 has a central portion 13 and bent end members 12 and 14 as shown. The loaf of bread 10 can be can be cut into slices for hanging on a holding system 60 as shown in FIG. 25. The system 60 has a horizontal wire member 62 and two legs 64 and 66. Lower ends of the legs 64 and 66 form respective feet 68 and 70 for supporting the system 60 on a surface. All parts of the system 60 are formed with a single wire.

It should be noted that a bread dough for the loaf of bread 10 shown in FIG. 24 can be hung in an oven when being baked. As only a small surface area of the dough is in contact with a wire support, more surface area of the dough is in contact with the hot air during baking. The indentations 22 and the shape of the dough allows a substantially even baking temperature to all parts of the dough and thereby the bread 10 is relatively evenly cooked.

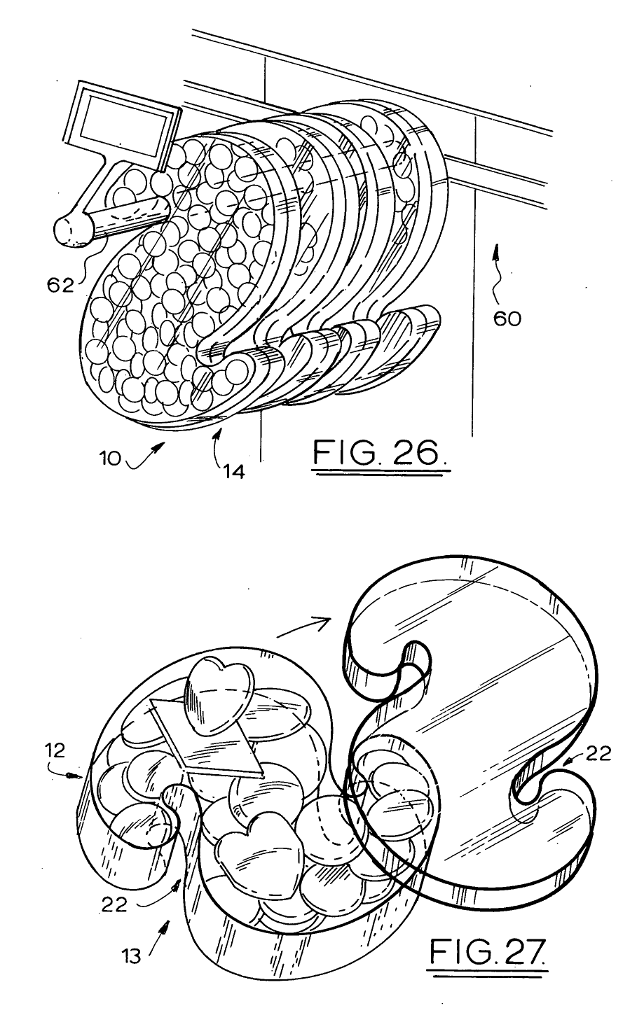

FIG. 26 shows a number of food products 10 being hung about a bar 62 of a display system 60. FIG. 27 shows one of the food products 10 shown in FIG. 26. This product 10 has a casing with a first end member 12 and a second end member 14 between which is a central portion 13. Indentations 22 are provided between the end members 12 and 14 and the central portion 13 as shown. For hanging the product 10, one of the indentations 22 is placed over the bar 62 as shown in FIG. 26. The casing has a base with a compartment for containing food elements of the food product 10 and a cover for closing the base.

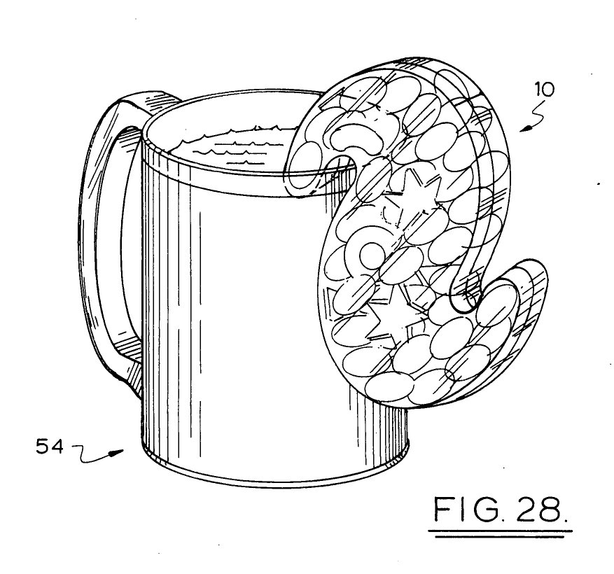

FIG. 28 shows a food product of FIG. 27 being hung about a mug 54.

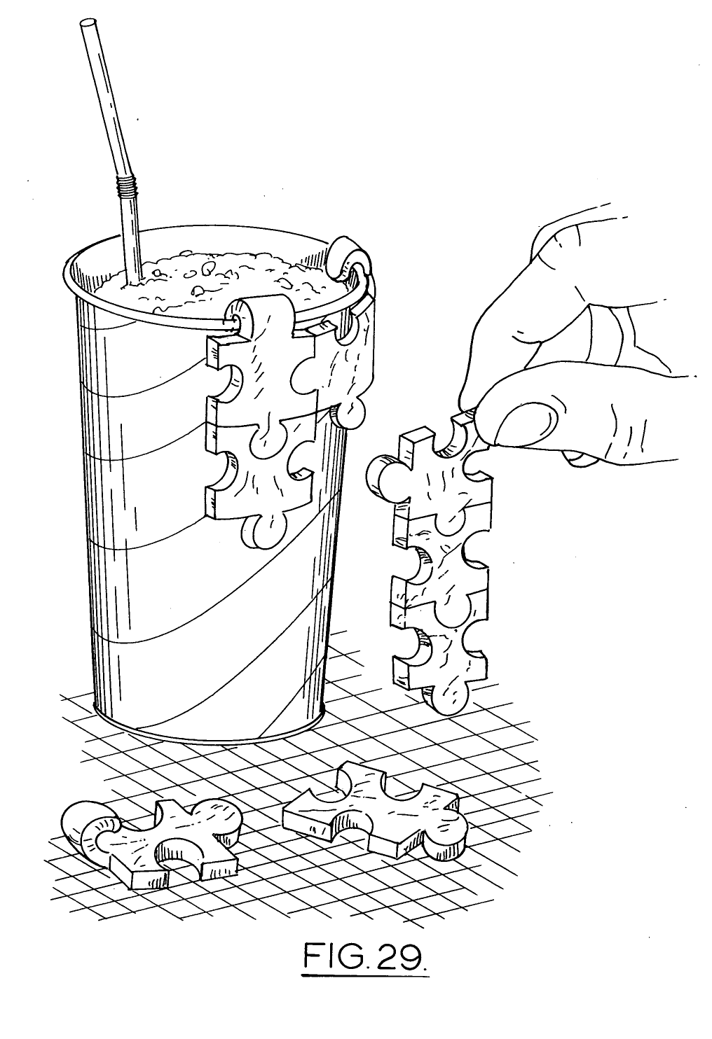

FIG. 29 shows an embodiment of the food product 10 which is made up of a number of interconnectable food elements. One or more of the food elements have a bent end member so that the food product can be hung about a drink container.

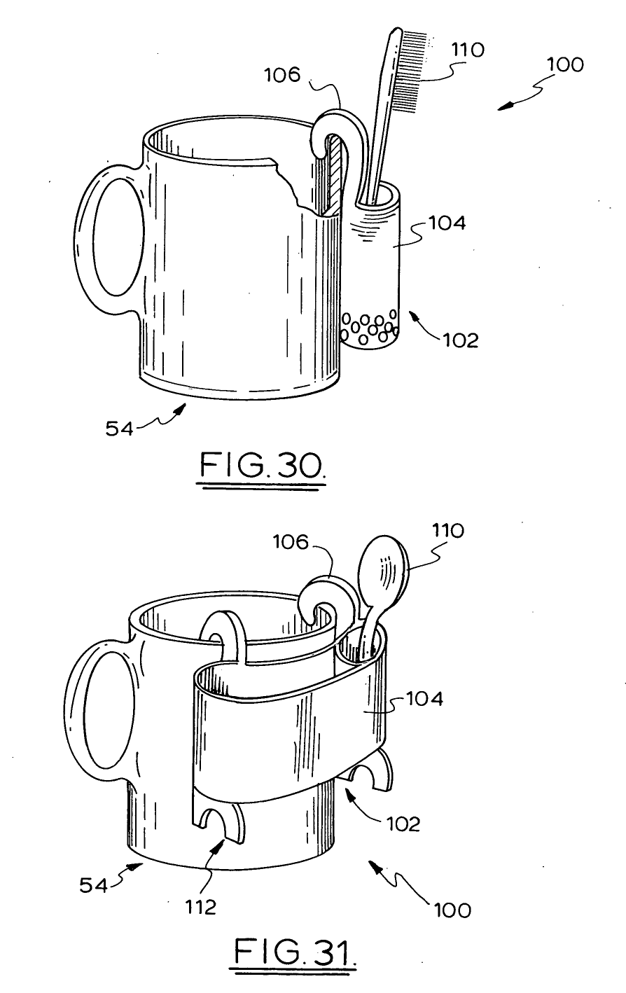

Referring now to FIG. 30, there is shown a holder device 100 for holding one or more articles 110 such as tooth brushes, and tooth paste containers; spoons, sugar, tea, coffee, or biscuits. The holder device 100 has a body 102 with a receptacle section 104 for holding the article(s) and a support section 106 configured for supporting on a part of a food or drink vessel such as a drink mug 54. The receptacle section 104 has a base with apertures 108 so that liquid in the receptacle 104 section can drain therefrom.

The support section 106 shown in FIG. 30 has a single support hook for hanging on the top rim of the mug 54 In the embodiment shown in FIG. 10, two such support hooks are provided.

The receptacle section 104 shown in FIG. 31 has two compartments, one for article(s) 110 in the form of spoon(s), and the other is for sugar, tea bags and coffee in bags. In this embodiment, the device 100 also has a leg section 112 so that the device 100 can stand on a surface.

Whilst the above has been given by way of illustrative example of the present invention many variations and modifications thereto will be apparent to those skilled in the art without departing from the broad ambit and scope of the invention as herein set forth.

What is claimed is:

1. A food product adapted to hang from a food vessel having an inner wall and an external wall terminating in a top rim, said food product including:
a body; and
a first hook formed by an indentation at one end of said body, said hook having a free end interned toward said body to attach the product to the vessel and provide three spaced contact points, a first contact point being between the free end and said inner wall, a second contact point being between said top rim and said indentation, and a third contact point being between said body and the external wall.

2. The food product of claim 1 wherein the third contact point is below the free end of the first contact point.

3. The food product of claim 1 comprising a second hook spaced from the first hook, said second hook formed by an indentation at one end of said body, said hook having a free end inturned toward said body to attach the product to the vessel and provide three spaced contact points, a first contact point being between the first end and said inner wall, a second contact point being between said top rim and said indentation, and a third contact point being between said body and the external wall.

4. The food product of claim 3 wherein the first hook and second hook are located at opposite ends of the body.

5. The food product of claim 1 wherein the body is formed in the shape of one or more of a real character, a created character, a plant, scenery, a work tool, a building structure and a vehicle.

6. The food product of claim 5 wherein the body is formed as a real or created character and the at least one hook is formed by an appendage.

7. The food product of claim 1 further including a space in the body, said space adapted to receive a handle of the food vessel.

8. The food product of claim 1 wherein the food vessel is a drinking vessel.

9. The food product of claim 1 wherein the food product is one or more of a biscuit, bread, cake, sausage and chocolate.

10. The food product of claim 9 wherein the food product is formed from bread, cake or sausage.

11. The food product of claim 1 wherein the body comprises two or more interconnectable elements.

12. The food product of claim 1 further comprising one or more throughholes.

13. The food product of claim 12 wherein said one or more through-holes are located in or adjacent the at least one hook.

14. The food product of claim 1 formed as a ladder, said ladder having a second hook spaced from the first hook, said hooks adapted to simultaneously hang from the food vessel.

15. The food product of claim 14 further comprising one or more food elements adapted to hang from the ladder.

16. The food product of claim 15 wherein the one or more food elements each include a hook formed by an indentation.

17. A system for storing a food product, said system comprising:
an elongate member arranged to extend horizontally; and
one or more food products formed according to claim 1, hung on the elongate member.

18. The system of claim 17 wherein the elongate member is supported by two or more spaced legs with upper ends extending from the elongate member and lower ends adapted to rest on a surface.

19. The food product of claim 17 wherein the elongate member comprises a fixing arrangement at one end, said arrangement fixing the elongate member to a rail of a display unit.

20. A block of edible material adapted to produce one or more food products according to claim 1 wherein the one or more food products are formed by slicing the block of edible material,

21. The block of edible material of claim 20 wherein the slicing is directed substantially transversely to a longitudinal axis of the block of food.

22. The block of food of claim 21 comprising bread, dough, cake, biscuit, sausage or chocolate.

23. A method of forming a food product adapted to hang from a food vessel having an inner wall and an external wall terminating in a top rim, said method comprising the steps of:
forming a body;
forming at least one indentation in the body to provide a first hook having a free end inturned towards the body such that the body will, in use, contact the food vessel at three spaced contact points being a first contact point between the free end and the inner wall, a second contact point between the top rim and the indentation and the a third contact point between the body and the external wall.

24. The method of claim 23 wherein forming the indentation includes the steps of turning an end member about a pin to a desired configuration.

25. The method of claim 23 further comprising the step of forming a block of edible material adapted for slicing to produce the one or more food products.

26. A food product including a body having a first member with a first free end and a second member with a second free end, the first and second members joined together or formed integrally, the first and second members configured so that at least one of the first and second ends form hanging means for hanging the body on the food vessel and wherein one or both of the first member and the second member is configured to locate about a handle of a food vessel and thereby support the food product.

27. The food product according to claim 26 wherein the first member is configured with a single indentation along an edge, the indentation shaped for resting over a top part of the handle and the second member is configured to rest on a lower part of the handle.

28. The food product according to claim 1 wherein the second member is shaped so that it extends into the handle or has an indentation shaped to receive the lower part of the handle.

29. The food product according to claim 28 wherein the body is formed as interconnectable pieces which when connected represent a real or created character and/or plant and/or scenery and/or work tool and/or building structure and/or vehicle.
